(19) United States
(12) Patent Application Publication
(10) Pub. No.: US 2024/0401880 A1
(43) Pub. Date: Dec. 5, 2024

(54) VERTICAL CONTINUOUS GRAPHITIZATION FURNACE

(71) Applicant: Graphex Technologies LLC., Royal Oak, MI (US)

(72) Inventors: Xingtao LI, Hong Kong (CN); Bin QIU, Hong Kong (CN); Frank YU, Hong Kong (CN)

(21) Appl. No.: 18/326,703

(22) Filed: May 31, 2023

(51) Int. Cl. F27B 1/10; F27D 11/10

(52) U.S. Cl. CPC F27B 1/10; F27D 11/10

(57) ABSTRACT

The application discloses a vertical continuous graphitization furnace According to this application, the electrode positive pole is located at a center of a furnace body, several graphite electrode negative poles are horizontally and axially symmetrically distributed with the electrode positive pole at the center of a heating chamber; the inner end of several graphite electrode negative poles and the arc-shaped inner wall of the heating chamber are on the same arc surface; the lower end surface of the electrode positive pole is in the same horizontal plane as the lower surface of multiple graphite electrode negative poles; the longitudinal cross-section of the heating chamber is in an inverted trapezoidal shape. This graphite furnace has the advantages of uniform temperature distribution in the high-temperature heating zone, which can ensure material consistency, temperature controllability, smooth exhaust and impurity removal, and the ability to prepare high-purity artificial graphite materials.

### TECHNICAL FIELD

The application relates to a graphitization furnace, in particular to a vertical continuous graphitization furnace.

### BACKGROUND

Currently, the traditional Acheson furnace is an uneven heating furnace with large temperature differences within the furnace. It is unable to produce continuously, resulting in significant heat loss. Additionally, its long cooling time, high energy consumption, low efficiency, and other disadvantages make it unsuitable for large-scale production. Compared to the continuous graphitization furnace and the Acheson furnace, the former can heat up quickly and save energy, shorten the production cycle, but it still cannot solve the problem of long cooling time, inability to achieve continuous production, and significant heat loss. Moreover, existing continuous graphitization furnaces have two electrodes placed in a one-dimensional symmetric manner at the bottom and top of the furnace. This creates issues with high electrode usage frequency and short service life.

### SUMMARY

The application provides a vertical continuous graphitization furnace in order to solve the existing problems of incapable of continuous production, large heat loss, high frequency of electrode use, and short service life. The specific technical solution to this problem is as follows:

The vertical continuous graphitization furnace according to the application includes a top gas collection channel, a water seal observation port, an electrode positive pole, a feeding port, a furnace cover carbon insulation layer, a furnace cover steel structure, a main flue, an exhaust observation port, an exhaust port, a graphite powder filling, a graphite electrode negative pole, a temperature measuring hole, a graphite block, a low-ash charcoal block, a refractory brick, a refractory concrete base, a cooling water pipe groove, a cooling water jacket, a graphite sleeve and a water collection tank; wherein the electrode positive pole is located at a center of a furnace body, several graphite electrode negative poles are horizontally and axially symmetrically distributed with the electrode positive pole at the center of a heating chamber; the inner end of several graphite electrode negative poles and the arc-shaped inner wall of the heating chamber are on the same arc surface; the lower end surface of the electrode positive pole is in the same horizontal plane as the lower surface of multiple graphite electrode negative poles; the longitudinal cross-section of the heating chamber is in an inverted trapezoidal shape.

### BRIEF DESCRIPTION OF THE DRAWINGS

FIG. 1 is a structure schematic diagram of the vertical continuous graphitization furnace according to the application,

FIG. 2 is a A-A section view of FIG. 1.

### DETAILED DESCRIPTION

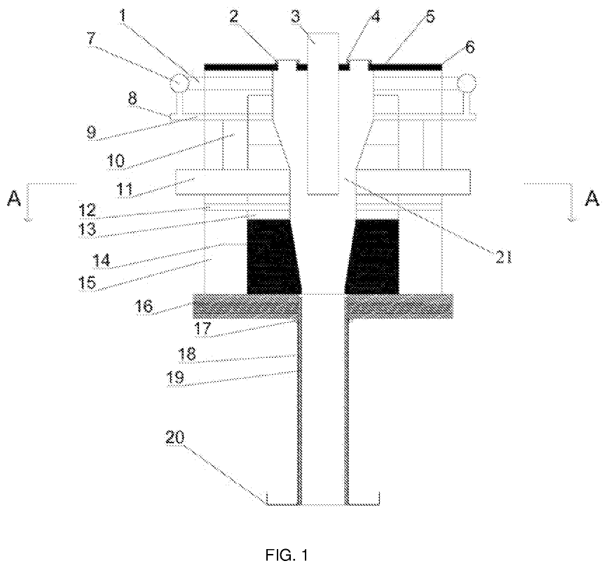

Embodiment 1: this embodiment is described in conjunction with FIG. 1. The vertical continuous graphitization furnace includes: a top gas collection channel 1, a water seal observation port 2, an electrode positive pole 3, a feeding port 4, a furnace cover carbon insulation layer 5, a furnace cover steel structure 6, a main flue 7, an exhaust observation port 8, an exhaust port 9, a graphite powder filling 10, a graphite electrode negative pole 11, a temperature measuring hole 12, a graphite block 13, a low-ash charcoal block 14, a refractory brick 15, a refractory concrete base 16, a cooling water pipe groove 17, a cooling water jacket 18, a graphite sleeve 19, and a water collection tank 20. The electrode positive pole 3 is located at the center of the furnace body. Several graphite electrode negative poles 11 are horizontally and axially symmetrically distributed with the electrode positive pole 3 at the center of a heating chamber 21. The inner end of several graphite electrode negative poles 11 and the arc-shaped inner wall of the heating chamber 21 are on the same arc surface. The lower end surface of the electrode positive pole 3 is in the same horizontal plane as the lower surface of multiple graphite electrode negative poles 11. The longitudinal cross-section of the heating chamber 21 is in an inverted trapezoidal shape.

This application provides a vertical continuous graphitization furnace that utilizes multiple graphite electrode negative pole configurations to reduce the usage frequency of individual electrodes and increase their service life. It also provides a uniform furnace temperature and balances material performance. Multiple graphite electrode negative poles are symmetrically distributed with the electrode positive poles on a horizontal axis at the middle of the heating chamber to ensure a relatively uniform current density flowing through the material and provide a uniform furnace temperature. The longitudinal cross-section of the heating chamber adopts a reverse trapezoidal structure, facilitating the discharge of impurities and volatile gases. The temperature distribution in the high-temperature heating zone is uniform and controllable, enabling the preparation of high-consistency and high-purity artificial graphite materials.

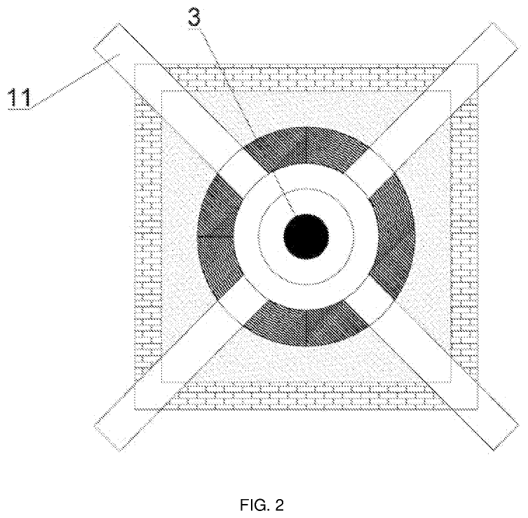

Embodiment 2: this embodiment is described in conjunction with FIG. 1 and FIG. 2. There are four graphite electrode negative electrodes 11 in the vertical continuous graphitization furnace according to this embodiment.

Embodiment 3: this embodiment is described in conjunction with FIG. 1. Water cooling method used by the vertical continuous graphitization furnace according to this embodiment is a spiral-wound water-cooling method, which uses the cooling water pipe groove 17, the cooling water jacket 18, and the collection tank 20 to provide power for water circulation, in order to cool the material. This greatly improves the cooling speed of the material and significantly reduces production time.

Operating principle: a cavity of a vertical continuous graphitization furnace is divided into four parts: a preheating zone, a heating zone, a constant temperature zone and a cooling zone. The heating cavity is in the inverted trapezoidal shape, and the preheating zone starts from the exhaust port 9 and gradually decreases in cross-sectional radius until the plane of the graphite electrode negative pole 11 is reached. As the cross-sectional radius of the preheating zone decreases, the material density increases and the conductivity improves. Upon entering the heating zone, several graphite electrode negative pole 11 are symmetrically distributed around the center of the heating chamber 21, with the axis of symmetry being the horizontal axis passing through the electrode positive pole 3. This ensures that the current flows evenly through the material and provides a uniform temperature inside the furnace. The material then enters the constant temperature zone, where it is cooled by spiral-wound water-cooling method to reduce its temperature and provide power for water circulation. This increases the cooling rate of the material, greatly improving production efficiency.

What is claimed is:

1. A vertical continuous graphitization furnace, comprising: a top gas collection channel, a water seal observation port, an electrode positive pole, a feeding port, a furnace cover carbon insulation layer, a furnace cover steel structure, a main flue, an exhaust observation port, an exhaust port, a graphite powder filling, a graphite electrode negative pole, a temperature measuring hole, a graphite block, a low-ash charcoal block, a refractory brick, a refractory concrete base, a cooling water pipe groove, a cooling water jacket, a graphite sleeve and a water collection tank;
wherein the electrode positive pole is located at a center of a furnace body, several graphite electrode negative poles are horizontally and axially symmetrically distributed with the electrode positive pole at the center of a heating chamber;
the inner end of several graphite electrode negative poles and the arc-shaped inner wall of the heating chamber are on the same arc surface; the lower end surface of the electrode positive pole is in the same horizontal plane as the lower surface of multiple graphite electrode negative poles; the longitudinal cross-section of the heating chamber is in an inverted trapezoidal shape.

2. The vertical continuous graphitization furnace according to claim 1, wherein the number of the graphite electrode negative poles is four.
